(19) United States
(12) Patent Application Publication
(10) Pub. No.: US 2006/0229108 A1
(43) Pub. Date: Oct. 12, 2006

(54) Mobile phone extension and data interface via an audio headset connection

(76) Inventor: Thomas G. Cehelnik, Tucson, AZ (US)

Correspondence Address: Thomas G. Cehelnik, PhD., 8300 E. Ocotillo Dr., Tucson, AZ, 85750, US

(21) Appl. No.: 11/346,725

(22) Filed: Feb. 3, 2006

Related U.S. Application Data
(60) Provisional application No. 60/650,016, filed on Feb. 4, 2005.

(51) Int. Cl. H04M 1/00

(52) U.S. Cl. 455/569.1

(57) ABSTRACT

A method and apparatus is present for achieving simple and inexpensive communications from wired phones to mobile or cell phones called a mobile phone extension. It is inexpensive because of flexible system architecture and simple hardware implementation. It allows phone calls to be made from wired phones over a cell phone. It is simple because audio signals from a microphone and speaker of a wired handset are connected to the mobile phone via a simple plug connection to the headset audio port. Alternatively, the system works with wireless connections between headsets and mobile phones. When the connection is made with a base station, it can be a wired or cordless phone or device acting as the base station. The disclosed system allows electronic apparatus to use a common mobile phone to link its communication instead of having an embedded phone separate from the user's personal phone. Other uses provide a means to communicate with a wireless headset while connecting audio from other devices such as audio devices such as players and records, and data devices. Even if the later is only speaker audio only, but it can contain microphone audio too. Thus useful apparatus and methods are claimed to connect mobile phones and wireless headsets with wired phone handset audio or other audio or video, and digital devices. One such audio player is the “I-Pod” known as a trademark of Apple Corporation. These devices can thus be connected with the disclosed interface, even when not using a wired phone, so audio from a cell phone and other devices can be received on the same headset. Use of gesture technology and particular command sets are also claimed for controlling devices using

[symbol]

### CROSS REFERENCE TO RELATED APPLICATIONS

This application is to receive the benefit of U.S. provisional patent application 60/527,690 filed on Dec. 5^{th}, 2003 which is now expired, and subsequent provisional application 60/650,016 filed on Feb. 4^{th}, 2005 and its corresponding supplements where Supplement I was filed on Mar. 1, 2005, and Supplement II was filed on Jun. 27, 2005.

### BACKGROUND OF THE INVENTION

This invention relates to an apparatus and method for distributing mobile phone calls to a local network of phone handsets throughout ones residence or office.

### BACKGROUND OF THE INVENTION

The popularity of wireless devices such as mobile phones or cellular phones is increasing so significantly that phone service companies are offering less expensive calling plans that include long distance. In turn, the cost of a home wired phone number is about $30 per month and increasing. In spite of this, many users still purchase wired phone service because there exists no other way to operate the wired devices on their home or office phone network. Some of the common wired phone devices include wired phones, cordless phones, FAX machines, and modems. This invention lets users of a mobile phone save money by foregoing the wired phone service while still using their wired home and office phones and networked peripherals.

Several reasons exist for users to continue maintaining wired services are:

1) There wired devices fail to operate without the wired phone service.

2) There exist no communication interface between their wired phone network and their mobile phone.

3) Another reason users seem to like the sense of stability from having a constant phone number of a wired line home service.

This invention address solves problems stated above in statements one ad and two. FCC recent law addressed the third reason. The FCC now insists mobile phone users are able to keep the same mobile phone number when switching their service providers and getting new phones. This ruling provides opportunity to have a consistent mobile phone number.

The stated problems above indicate mobile phone technology has not yet interfaced seamlessly with the communication networks of the home, office, or business.

What is really needed is a method and apparatus to avoid the double charges for maintaining wired and wireless phone service while still allowing the user to operate their networks in the home and office.

The new technology should avoid the sudden and costly upgrade of all individual devices on the wired network. This approach allows users the comfort of using their existing peripherals. This is important because many users have specific devices they are comfortable with and have no need to replace. For example, the peripherals may be a full sized handset or a speakerphone for the ease of hearing. Other devices may include specific features to assist the elderly and physically challenged users such as phones with oversized buttons for the ease of dialing, or devices made for the hearing impaired individuals. The replacement of these devices is not a feasible option for many consumers. Still these users may still prefer to have only a mobile phone service but cannot forego the wired service because they cannot user their special wired phone devices. So what is needed is a method and apparatus to connect their mobile phone service to the wired networks in the home and office so they can forego paying for a wired phone service.

To address this need this invention uses a basestation or phone server that makes available the mobile phone through the wired phone network in the home and office.

Another problem encountered at home by most wireless mobile phones users occurs while charging the phone. Most mobile phones come with a charger in the form of a cradle. Many times when charging a call comes in and the user either misses the call because the phone is not turned or they missed the call because the wireless mobile phone was too far away for the user to pick up the call in time. Thus what else is needed is a connection to the wired network of the home and office from the wireless phone that allows the user to charge the mobile and us phone extensions located in proximity to the users at the time a call needs picked up or placed.

Additionally, other connections are needed for convenience in assisting with communication in the computerized world such as speakerphone, keyboard, viewing screen, and Internet and E-mail access.

Also, some users in the home or office may not have a mobile phone. In this case the use may still wish to have an option for placing some of their call through a wired phone service. This is useful for toll free calls where one expect to have to hold for long periods. Also in order to save wireless airtime minutes, a wired phone service for communication to vicinities in the local area of the home or office may be desired. For example someone may access a computer dial up connection for the Internet and E-mail. However, when long distance calls are placed, the mobile phone service is switched onto the wired network and the basestation and phone extensions are used during the call. This approach also can save money for the user of this invention. Thus what is needed is a method of switching between mobile and wired phone services.

Some users may not receive a significant mobile phone signal in the home or office building and thus some user locations may require a signal booster.

Also, many people in a household have individual phones and numbers. They also carry the phones between the home and office. Thus what is need is a way to connect these multiple users to the wired phone network when at home or the office. This invention allows multiple mobile phones to serve the wired network.

To keep costs low, it the connection method should allow any phone to connect. The invention does so through the audio headset jack on the mobile phone and an audio headset jack on standard telephone. Thus there is not a direct connection of a mobile phone to the wired telephone network. This is significant in that it releases the manufacturer of mobile phones from getting FCC approval for the connecting to the wired lines. Additionally, mobile phones without local short range wireless connections like Bluetooth will also be able to use the system, and keep cost to the consumer down. The mobile phone can be made to connect to a basestation comprised of wired phones with either corded or cordless phones. The basestation can also connect either physically or an RF connection to other wireless headsets such as Bluetooth or other cordless headsets that then make a connection to the mobile phone.

In summary, what is needed is a basestation or phone server that makes available the mobile phone through the wired phone network in the home and office for a variety of off-the-shelf mobile phones. Such a basestation may also include:

1) A method to charge the mobile phone; 2) Provides a capability to switch between wired and mobile phone service; 3) Assures good mobile phone signal in the home or offices by offering a connection to a wireless signal from a high gain antenna located in a good signal area or by nearby repeater; 4) Connects to a computer for usual computer uses such as keyboarding, viewing, audio controls, and connection to the Internet; 6) Allows for multiple mobile phones to be connected to the network.

Thus one aspect of the invention is to provide a method and apparatus for connecting mobile devices such as mobile or cellular phone, pagers, or palm devices or computers to a communication network in the home or residence.

Yet another aspect of the invention is to connect a mobile phone handset to a wired phone extension unit in a residence or office. The handset to the wired phone extension may be a wired corded, cordless, or a wireless device.

Yet another aspect of the invention is to connect a mobile phone handset to a communication console in a residence or office via a local communication conduit that may include a wireless network but terminates the mobile phone long range RF at the mobile phone handset.

Another aspect of the invention is it improves the ease of communication by connecting wireless mobile phones through a local wireless network or via direct plug into a mobile phone charger unit with added local communication capabilities to the home or office devices as described in the preferred embodiment and claims.

Another aspect of the invention is a speakerphone and charger capability on a communication console that holds the mobile phone.

Yet, another aspect of the invention is to provide for a keyboard and a viewing screen. In the preferred embodiment of the invention these items, along with speakerphone, and charger into a communication console for the home.

Yet, another aspect of the invention is to provide part or all of the above features through a communication conduit in the residence or office wiring. This conduit includes wired networks, or wireless networks, that carry the wireless phone audio and digital data from a mobile phone to a wireless phone console. The said console distributes the data to other peripherals and computer resources in the home or office via said communication conduit.

Yet another aspect of the invention is to provide a means to boost the mobile phone signal in the home such as in the form of a repeater in the local area to the user or an antenna connection provided to the basestation.

### BRIEF DESCRIPTION OF DRAWINGS

The invention will be better understood upon reading the following Detailed Description in conjunction with the drawings attached.

FIG. 1 depicts a communication network from the wireless mobile phone to a charger unit that distributes the call to phone extensions within the home or office through the wiring in the home.

FIG. 2—Shows 2.5 mm or 3/32″ phono jack for plugging into cell phone.

FIG. 3—Shows ⅛″ phono jack for plugging into basestation headphone jack.

FIG. 4—Shows LG 4400 Cell Phone uses with system.

FIG. 5—Shows Phone Extension Interface Card input and output connections.

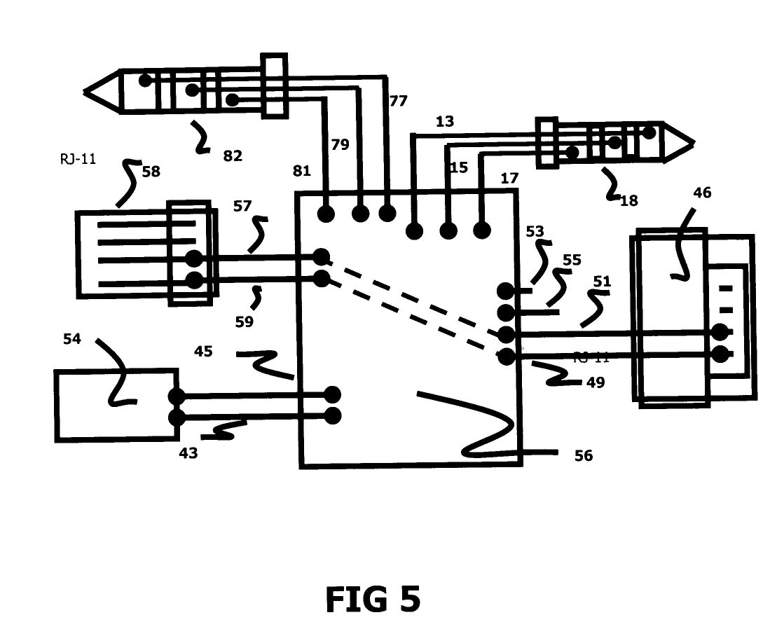

FIG. 6—Shows Phone Extension Interface interconnection drawing.

FIG. 7—Shows schematic of Phone Extension Interface card.

FIG. 8—Shows schematic of Phone Extension Interface card power supply and phone-wire connections.

FIG. 9—Shows charger holder with a means using solenoid actuators, robotic fingers, for activating cell phone signals occurring when cell phone buttons are pushed.

FIG. 10—Process flow diagram for a mobile phone extension illustrated in this disclosure that is independent of the specific communication protocol or modem capability of the mobile phone. Thus demonstrating that this invention is applicable to existing off-the-shelf equipment.

### DESCRIPTION OF THE PREFERRED EMBODIMENT

To those skilled in the art of telephone and data communication electronics many variations and connection conduits including local wireless methods will become obvious; nevertheless this preferred embodiment any claims are to include such variation.

Mobile wireless communication operates with various RF modulation and coding techniques at frequencies in the GHz. Though the details of the mobile wireless phone are not necessary to understand the invention; one fact is. This is the fact that the mobile phone RF connection to the large area network stops at the mobile phone. The invention makes an additional connection linking the audio or data signals throughout the home or office. Said another way, this invention makes the mobile phone connection available throughout the local vicinity of the home, office or area of a local area network. The connection is available on other phone extensions or networked appliances such as palm PCs. In this way the invention eliminates the need for a wired phone service; hence results in a cost savings by reducing phone line service charges, including monthly connection charges, and charges for calling options such as voicemail, call waiting charges.

One method is to use a local wireless link. In this method those familiar with mobile phone engineering will identify alternative electronic approaches to achieving the claimed effect. One way is receive a signal from the basestation in the local area in an audio detect mode and then use a modulator to down converted mobile RF frequency. This is the RF frequency is converted to a convenient local area RF frequency, perhaps 900 MHz or more. The signal is modulated for the transmission of the audio and digital data locally in the home or office. The modulation may be coded either digitally or via analog approaches so as to achieve a means of communication with the basestation and network.

Simply stated, the mobile phone contains a transceiver for local communication to the phone network. The transceiver is embodied within the mobile phone handset or in a separate attachment unit consisting of a phone extension interface with a wireless transceiver.

Operating in this cordless mode, an auto-detect feature connects the mobile phone on the home network when it is located within the vicinity of its associated basestation. This cordless method interfaces the mobile phone using the said local transceiver module as an additional handset or phone extension to the home basestation. The basestation distributes the information via signals to the devices on the local network.

This method offers cordless connection of the mobile phone to the home or office network. The described method is a novel expansion of the readily available cordless phone basestation; but now the invention allows for these cordless wired handsets and peripherals to use the mobile phone connection. Furthermore, the invention is a basestation that connects to other wired and non-wired peripheral devices. It offers the specific money saving possibility and convenient feature of making the wired phone network operation without having a wired line service provider. In this way, the invention makes possible the convenience of using the home network peripherals including the conventional wired phone extensions. Such peripherals are expected to remain in households and offices for some time before being replaced by completely wireless units.

In the preferred embodiment the wired line service provider is not required. In the case where a wired line service provider is employed, for various reasons of the user, this invention offers a switch for disconnecting the phone signal wires from the service provider. This option prevents the billing of a wired call when the mobile phone is used for the connection.

Another claimed approach is to plug the mobile phone into a basestation. The wireless mobile phones usually offer a connection to a data port and audio signals from a headset containing a microphone and speaker, or speakerphone. The data can be audio such as voice and modem data in either analog or digital form. The wireless mobile phone transmits this data to the charging console in the home or office via a local wireless network communication, such as a 900 MHz signal used for cordless phones. Thus the mobile phone is made cordless to the charging console that is connected to the local home or office hard telephone wiring. A switching circuit is used to detect the RF signal arriving in the charger, it is then demodulated and switched to the local hardwired phone lines in the home. A ringer circuit is also provided so the ring can be triggered to other phone extensions in the home or office. Additionally, a non-cordless option is invoked when the wireless mobile phone is in the charger via direct wire connection through a connector between the wireless mobile phone body and the charging console. Additionally an option exists on the said charging console for speakerphone. A keyboard and viewing screen is also available through a communication port using standardized protocol connecting the digital data to an embedded microprocessor or and external PC that handles the digital communication between the wireless mobile phone and basestation. User control of the system is provided by computer interfaces program that the user interacts with the system through peripherals of choice from a PC such as a keyboard, mouse, and video screen. Additionally, some buttons useful to the operation of the basestation are also included on the basestation unit, such as phone extension page.

The phone extension invention is also useful for systems and services made available to the public requiring a telephone connection. These include Kiosks that provide computer access to the Internet and e-mail services. One such concept for the future are Kiosks to allow access to larger video displays and computer peripherals from their telephone or pocket device. The phone extension or server allows kiosks and other systems to pay for the phone calls with the customers own mobile phone service. This is useful too because the mobile phone are smart and usually contain databases of phone contact information, email addresses, and other useful contact information that is made readily available with the cell phone.

### DETAILED DESCRIPTION

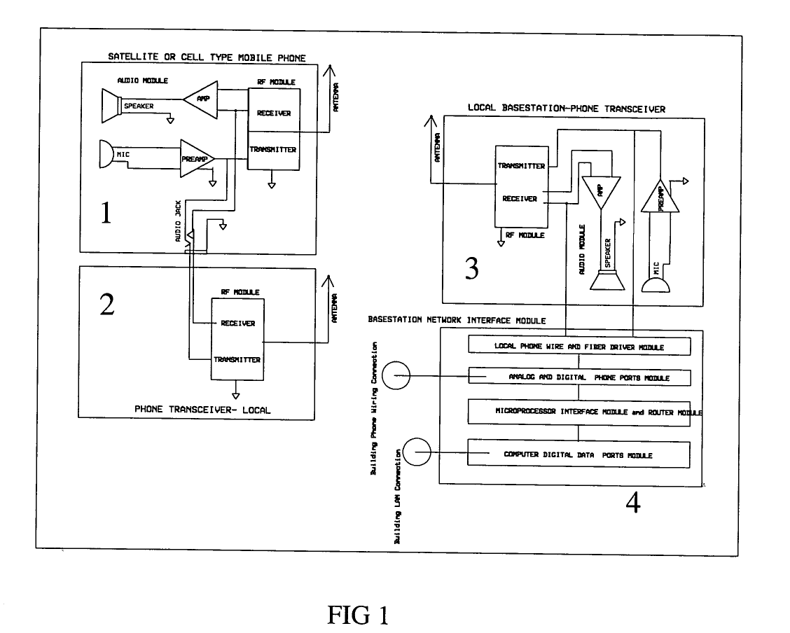

The invention is block diagrammed in FIG. 1 for the case of having short-ranged local-transceivers to communicate between the mobile phone and basestation. If the user mobile phone is not equipped with such a local-transceiver, it can be purchases as auxiliary module that attaches to the mobile phone in an ergonomic and convenient fashion. The local-transceivers communicate the audio and data in two-way communication between the mobile phone and the basestation. The method of linking the audio data is illustrated in FIG. 1. FIG. 1 shows the signals from the speaker output of the cell phone connected to the microphone input of the basestation. It also shows the signals from speaker output of the basestation phone are connected to microphone input of the cell phone. These signals are available between the headset jacks of the mobile phone and base station. These signals at the headset jacks also require conditioning circuitry to eliminate DC signals or the phones can be damaged. The DC is there from offset in amplifiers, differences in ground potentials, and primarily because headset are designed to have a DC voltage to bias the microphone. Acoustic signals entering the microphone cause electrical audio signal on the microphone wire. The basestation then connects to the phone network to distribute the signals to the phone extensions and peripherals.

The local-transceivers today are of the digital type. They use spread spectrum encoding to achieve security from interception and interference. They also transmit computer data readily in common formats. In wireless and cordless phones, and digital wired phones these signals may be available in digital form within the phone. This way a local-transceiver within these phones may be connect internally to these signals during the design of the phone. In other cases, a digital port may provide these audio signals from the phone along with control signals. The signals from the headset jacks are analog type and must be converted to digital form with an analog to digital converter or A/D before sending to the local-transceivers. Thus the digital nature of transceivers allow for options to get the signals from the mobile phone, and whether the signal need to be digitized with an A/D.

We also recognize in this disclosure that the invented method requires a means communicating the audio, control data, and digital data between the mobile phone and the basestation. The frequency and modulation scheme of the transceivers may vary in applications. For example local-transceivers can be made from two pairs of 900 MHz transmitters and receivers connected to make transceivers that communicate between the mobile phone and the basestation. Another means of communicating the data is to use Blue Tooth transceivers. Many such transceiver chips have onboard A/D converters. Later on in this disclosure, the circuitry is detailed describing the mobile phone extension by connecting the analog signals from the headset jacks through circuitry with wires. The use of the wireless local-transceivers instead of wires is recognized by analogy. Even though a particular phone technology may require changed in the manner in which the signals are process, the method of this invention for making a mobile phone extension remains unchanged.

The mobile phone buttons on the keypad 23 are controlled with the buttons on a phone extension or basestation 67. Each time a button on the basestation or phone extension is pushed an audio dual tone signal is sent on the phone line, or a touch-tone. Decoding these touch-tone signals with control circuitry added to the Phone Extension Interface card 56 recognizes the activated buttons. Digital commands corresponding with buttons pushed, or sequences of buttons, are sent to the mobile phone through the basestation local wireless-transceiver. The signals are received by the mobile phone local wireless-transceiver and passed to its controller to activate the buttons or corresponding command.

The phone extensions may be either wired corded or cordless phones, or even a wireless phone or device that connects directly to the basestation. The phone extensions are connected to the basestation 84 with the phone wiring 58 via the Phone Extension Interface card 56. If the user remains with their original phone as a basestation, thus not having a transceiver, then the Phone Extension Interface 56 would be a separate item sold to the user. On the other hand it can also be integrated within the basestation. A useful feature of this invention is there is no need to upgrade the peripherals attached to the wired network. This saves the user money.

Another useful and distinguishing feature with this invention is the basestation provides the standard wired telephone signals wired signals such as power, dial tone, ring detection and ring generation, and busy signal, and caller ID. The basestation then sends these standardized and necessary signals over the wiring of the home or office to activate the users phone extensions and network peripherals. Prior to using the basestation the connection of the wiring in the home or office should be disconnected from the wired telephone service line. This is done manually or an optional switch not shown may disconnect the wiring from the wired phone service interface at the input to the wiring in the home or office.

The basestation may also contain a connection to a computer that can also be established through various means such as a wired modem, network connection like Ethernet or wireless Ethernet provided in the basestation, or USB. A charger cradle is at times conveniently included in the basestation to charge the phone. A plurality of chargers may also be used to accommodate multiple handsets if the basestation is cordless, or additional mobile phones. These connections are not described because the technology already exists but has not been integrated into a Mobile Phone Extension as disclosed here.

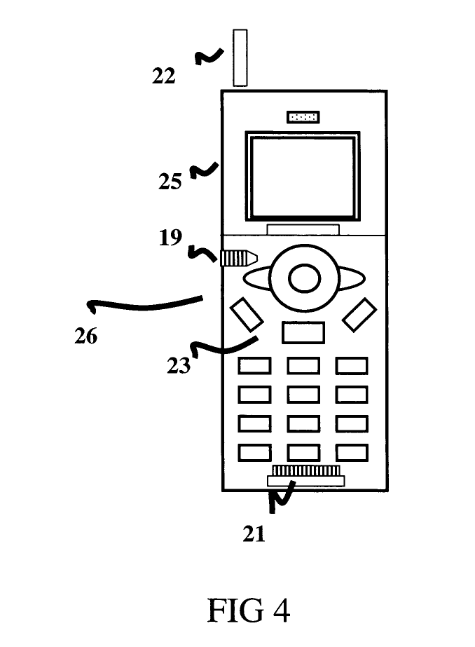

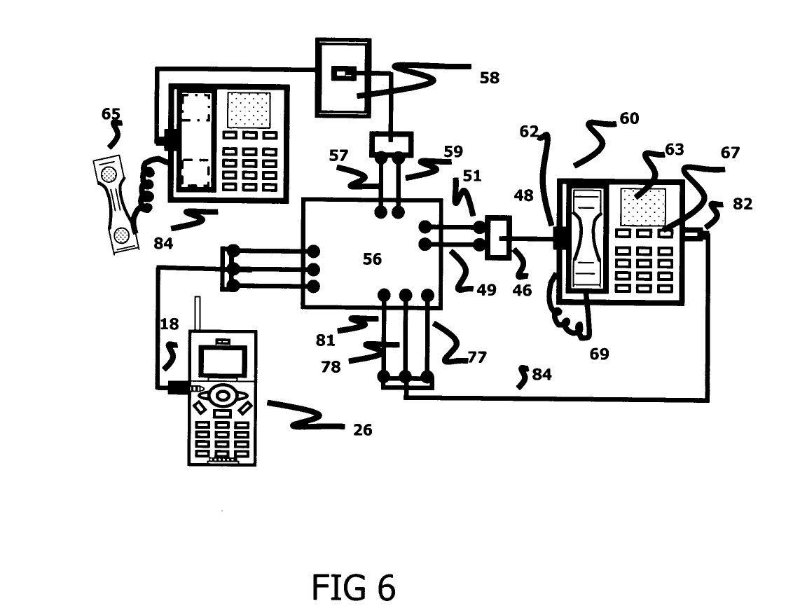

It is also possible to have a wired connection between the cell phone and the basestation. The cell phone plugs into the basestation in this case and the audio and data are exchanged. To disclose we explain in detail a phone extension system using the said method above. The described system has the convenience to allow cell phones commonly available without a local transceiver to be connected with a simple telephone as a basestation with a piece of auxiliary equipment called the Phone Extension Interface card shown in FIG. 4. To do this the mobile phone is connected via its headset jack to the phone Extension Interface. Such a connection is makes the invention also convenient to work with no special cell phone equipment other than the basestation. The wiring connections are illustrated in FIG. 6 for the system. A description of its operation is now given.

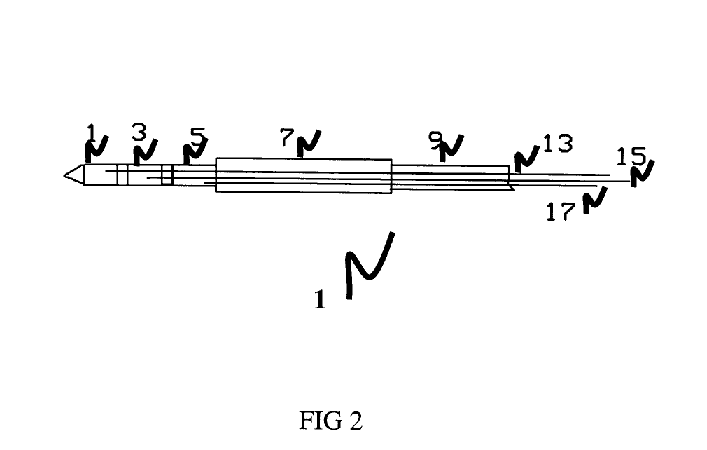

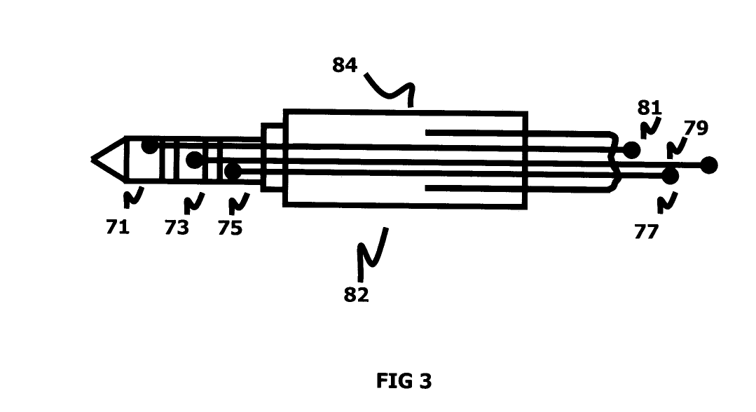

The mobile phone is the demonstration is an LG4400, but other phones will work fine if the headset jack is wired the same. For noncompliant cases, the circuit is generally applicable, just the pin connections needs reordered. FIG. 2 shows a 2.5 mm male stereo phone jack 18 that is used to connect the phone extension interface card 56 to the mobile phone female headset jack 19. FIG. 3 shows a ⅛ inch stereo phone jack 82 used to connect the phone extension interface card 56 to the basestation headphone jack.

FIG. 4 illustrates the characteristic of the mobile phone. The 2.5 mm stereo phone jack 18 of the PEI is used to connect to the mobile phone through the headphone jack 19. The keypad 23, and Flip-up ears piece 25, and antenna 22 are indicated. The data port and power charging port 21 is also shown. The phone also has an external antenna port on the back that is not shown.

The basestation phone 60 and the phone extension phone 84 are both just common wired phones. They are Durabrand corded speakerphone with a headset jack 82. FIG. 6 shows the connection diagram to exchange audio from basestation 60 with a wired-phone extension 84 connected to the wall jack 58 of the home or office. The system was tested under a simulation condition of having no service provider. To do so we connected the phone extension 84 to the phone extension interface 56 with wire through a RJ 11 wall plug 58. After all this is the benefit of the invention, to allow people to use their home and office equipment without a service provider.

The audio signals received on the cell phone 26 are connected to the extension phone 84 for communication on its handset 65 through the Phone Extension Interface card 56. Of course the speakerphone or headset connection of 84 may be used alternatively to the handset 65. Also more than one extension phone type such as cordless or wireless is possible as an extension. It is connected to the phone wiring in the home or office through another RJ-11 wall jack 58 not shown or some suitable equivalent connection. It is also possible for the basestation to be a cordless phone so it can reach other handsets belonging to it that will function as an extension. In the later case the cordless basestation must also have a headset jack.

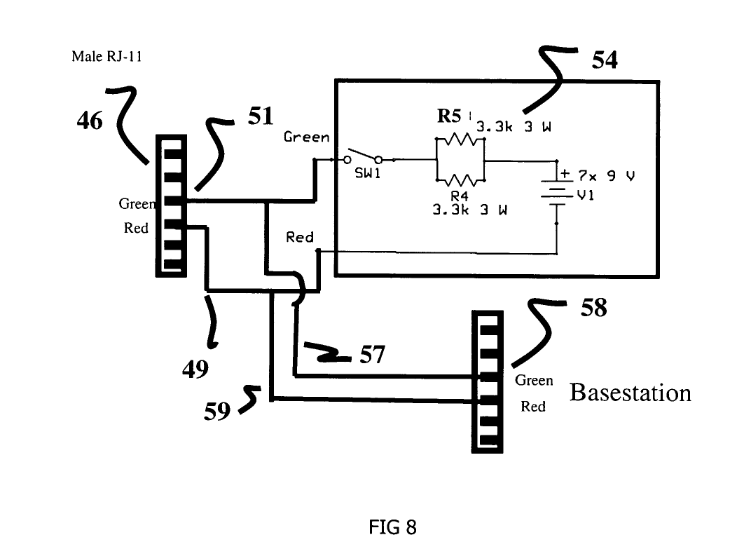

The basestation phone and extension phone are Durabrand Model PH-323 purchased at Walmart. Internally these phones are set to headset mode with the push of a button 67. These are powered with a power supply 54 of FIG. 8 that accompanies the basestation interface card. It is used to power and activate the phone line inputs of these phones. The power supply used in my test is shown in FIG. 8. The switch SW1 is used to energize the phones and lines between the basestation and extension phones that may be automatically activated when the cell phone connects or no other wired service is detected on the wired lines. The FCC sets equivalent wiring circuits for such power supplies. Thus they may require additional circuit components for safety protection and to preserve signal integrity. These may include but are not shown in the FIG. 8 a parallel capacitor of 500 μF and a series inductor up to 10H with the voltage supply V1, and other components. The FCC specifies operational tolerances on the voltage and the equivalent source impedance presented to the phone lines.

The purpose of the power supply in FIG. 8 is to allow the operation of the invention for demonstration purposes. Additional circuit and components may be added to the power supply in order to make the power supply compliant with FCC rules.

The invention generates additional signals and voltage supplies and modulation as required for common telephone signals such as rings and busy signals, on hook, and off hook. Although this invention is described in detail for an analog phone system, it also applies to a digital phone system in the home or office. Those skilled in the art are able to use the information disclosed on this invention to modify the disclosed power supply and provide circuits to generate the telephone signals in both analog and digital for required for a commercialization of the invention and to assure FCC compliance. These circuits process command signals from the Phone Extension Interface. For example a ring signal comes in and placed on the audio lines of the phone extension interface. The signal is recognized by a processor which issues commands to the said signal generation circuitry. The circuitry then sends the required analog 20-30 Hz high-voltage ring signal over the phone lines in the home or offices. At times the phone lines conditions are monitored to when the phone call is terminated. However, it is equally good to use a terminations tone sequence on the audio line. In either case, the audio signal and phone line signals are monitored by the processor and logic is applied to issue generate the appropriate phone signals from the power supply card. The energy from the power supply may be provided by a battery source, or by converted main A.C. power. The signals types and power types depend where in the world the product is used.

To operate the phone extension we first turn on the power supply through SW1. Next we make our connection to our extensions by setting the basestation into headset mode by pushing a key on the keypad 67. The mobile phone 26 is then dialed or answered by pushing the required buttons on the mobile phone. The call is then taken on the extension phone 84. Pushing the end button on the mobile phone terminates the call.

It is recognized that one packaged form of the invention is as an interface card and a power supply with phone jack connectors to patch in the mobile phone to another phone acting as a basestation. Another is to package a holder for the mobile phone and the electronics of the phone extension interface card within the basestation. The holder may also include a charger and support electronics to establish and issue commands to the mobile phone from the extension.

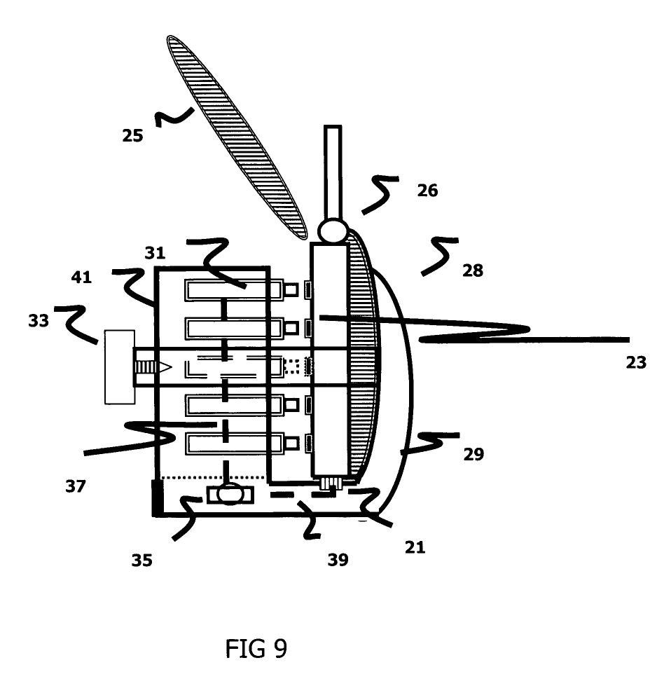

FIG. 9 shows a holder 28 for the cell phone that also acts as a charger. It also provides the electronics and mechanisms for controlling the actions of the cell phone from the phone extension. The commands to control method is indicated in the FIG. 9 schematic that shows the mobile phone 26 in a charger unit 29 along with a finger robot. The finger robot uses actuator fingers 31 to push the buttons of the mobile phone. The actuators are solenoids like model EC-30 from Electromechanisms of San Diego that are energized when logic circuitry detects the keys pushed on the extension by a touch-tone decoder circuit not shown here.

A power supply is required for the actuators, as well as any signal condition circuitry and protection circuitry not shown. The actuators operate on DC power and DC is switched to actuators by the microcontroller driving transistor switches to each one. The power is routed through wire connection 35 on the charger and run up through circuit board 37 that contains the switching transistors, logic driver, and signal decoder. The control signal may be coded in simple serial or parallel. The controller can reside on the Phone Exchange interface. The cable feeding 35 must accommodate the number of wire conductors needed for the communication protocol. If parallel means is chosen, 8 conductors are required for 8 bit communication that is sufficient. A binary to decimal decoder is used as a logic chip with its outputs connected to the base of the transistor switches that can be 2N222. The duty cycle is low when actuating the buttons. At 24 VDC drive voltage the actuators draw about 83 milliamps. The base will be at 1.6 volts and the emitter at 1.0 volts with an emitter resistor of 12 ohm. The output from the logic chip is 5.0 on state, and we divide by two with a 1 k O voltage divider. Thus the drive voltage of 25.6 V should work well. The power supply card of 54 in FIG. 8 will also contain the power supply that is not shown for these devices. The choice of the power supply voltage is a matter of convenience, as the actuators may be custom designed for operating voltage and current. The force and travel of the actuator are dependent upon distance. To increase the force the distance must be keep small. To help with this a slight prestress is set on the buttons of the mobile phone with the jack screw that is snugged up by the thumb wheel.

The robotic fingers 31 are initially positions over the significant keys of the mobile phone. The fingers are pressed against the keys of the mobile phone by a mechanical member that is either a strap, band, or bracket in combination with and jackscrew 33. Some foam is also optional not shown, to help snug in the phone, but leave the buttons clear to contact the actuator fingers. The finger actuators are housed is in a panel 41 that allows for adjustment of the position of the actuators. Also the panel slides to and fro from the backplate 29 thus allowing an adjustment of the gap between the panel and backplate. These two features allow for various types and sizes of mobile phones to fit the finger robot apparatus. The power for the charger and actuators are provided through electrical connector 35. The cell phone 26 dataport 21 is also available at the electrical connector 35. An external mobile antenna, not shown, is also another accessory to the system to enhance indoor signal levels. The antenna plugs in the back of the mobile phone through an opening not shown in the backplate 29.

The robotic fingers give one method to control the mobile phone by sending signal when pushing the buttons on the phone extension of basestation phone. Relatively few fingers actuators are need for just answering but more are need for more complete robot for dialing. Thus what is claimed is at least one finger actuator but more generally we claim a means of controlling the mobile phone operation.

Other means are now described for controlling the mobile. A way is to send voice commands to a mobile phone that has voice recognition such as speed dial. Some cell phones also have voice recognition capability to recognize numbers and alphabet letters dial and activate keys on the phone recognition. These verbal commands would be activated on an appropriately equipped mobile phone by the audio signals relayed to the mobile phone through the basestation from verbal commands issued on the extensions. Another method is send commands in the form of wireless message sent between the basestation and the mobile phone upon the basestation recognizing a command from the audio stream the may include touch tones or voice commands. Yet another way is to have a voice and data modem internal to the mobile phone that the bases station connects too.

The LG4400 only has a data modem that is controlled by computer data sent to the data port. A voice modem is needed to connect the audio so conversations can proceed by initializing the phone data port with a digital command from a PC or microcontroller. Other mobile phones may have this capability. In this case a microcontroller having memory and a communication module, or a computer, connected to the data port of the mobile phone can open a connection, dial the phone, provide ring detection, and answer the phone.

A means of communicating between the basestation and the phone extension is another requirement. This way commands from the phone extension be interpreted by the basestation and then issue the commands and exchange of data by the said means of communication between the mobile phone and basestation.

On analog phone systems, the preferred method of communication between the basestation provided from commands issued from the phone extension through touch-tones, or other associated signal detected by the basestation when functions on the phone extension or handsets are activated. Since the typical wired phone does not have a one to one correspondence of buttons, some key or a combination of keys are used to issue mobile phone commands like send. For example the *, or *# may be recognized by the basestation to issue a “talk” or “end” commands. These can even be programmed in the basestation to the desire of the user.

Thus we have disclosed several means for controlling the mobile phone from the phone extension. The control electronics can be packaged in phone extension interface module, or within the basestation. To this point of our discussion, the control electronics consist of a computer or microcontroller with control ports, a microcontroller program to control the operation of the system, memory, a touch-tone decoder, and touch tone generator. Plus control circuitry must be included to detect signals and generate signals occurring on wired phone systems. These include a ring detection circuit, ring generator circuit, busy detection and generation, dial tone generation, and wired phone power, plus any other communication modules required for caller ID. These apply for digital or analog phones.

Signal conditioning circuitry is at times convenient to include in the system. This circuitry enables a reduction in echoes and background noise, and maintains signal levels with amplification that are at times needed with longer runs of wires and for networks with more phone extensions or peripheral. The signals can be conditioned either to produce analog or digital signals for transmission to other devices and networks. For digital processing the base station may include an analog to digital converter A/D, digital signal processor DSP, a program for the DSP to run in order to perform its functions, memory for the DSP, and a connection to digital networks such as a LAN. For analog signals there may be analog circuits and filters, and amplifiers, plus a connection to an analog data channel and loudspeaker and microphone for external use. These options exist for the invention is not limited to having all of these features.

For the mobile phone carriage charger unit, we include a mobile phone charger, power supply, and a means for controlling the operation of the mobile phone like robotic fingers. For this case we require solenoid power, solenoid signal conditioning and logic switching circuit. When the means is wireless communication to control the mobile phone operation, we require a basestation and mobile phone equipped with short-range transceivers.

We recognize the systems described works for not just a wired extension but also with wired cordless phones. The invention described also works with mobile phones and basestation with and without wireless transceivers. It also works in manual mode with common phones in the home or office.

In this simplest case when the basestation may be just a usual phone with a headphone jack, and the phone extension interface card and power supply will connect the mobile audio to the wired phone extensions and peripherals. In this case the cell phone call can be transferred to a bigger handset, or speakerphone over a phone extension. The call can be taken by the basestation or on an extension. By implementing a means of controlling the mobile phone from the phone extension complete audio voice and touchtone data is exchanged via the phone extension.

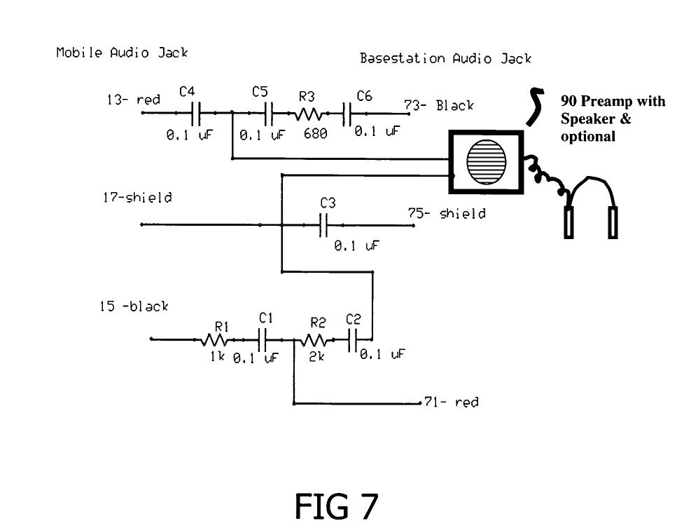

If by accompanying the cell phone extension card with an amplifier speaker as shown in FIG. 7, it makes for a nice way to hear a phone call instead of having the mobile phone to ones head where the RF may be a concern, or where those with hearing impairments may have difficulty. A Radio Shack audio amplifier and speaker part number 277-100BC. Similar a microphone can be connected to the microphone port, and a speaker phone can be made there as well.

To use the basestation handset 67 with the mobile phone and external speaker 90 the connections marked 73 and 71 on FIG. 7 need to be reversed. This is easily done manually by a switch or automatically when the handset of the basestation is picked off the hook. The cross over switch can be in the Phone Extension Interface card or the basestation. The physical location does not impact the invention as long as the process operates.

It is noted that in FIG. 7 there exists antisymmetry in the circuit topology. Also this circuit is unexpected and not obious as it does not use any switches and sufficiently isolates the speaker and microphone channels with exceptional audio quality and no noticeable delay or reverberation between channels. Many speaker phones have the problem of reverberation between audio and microphone channels, and require signal processing to cancel the reverberation. This circuit surprisingly does not add detrimental reverberation or cross talk between the speaker and microphone channels perhaps because of the balance in phase delays in the interface circuit. Such an audio connection can be used in any devices that has an analog speaker and microphone channel and thus many uses are envisioned in either audio jack connections or internal electronic connections. This is because the audio signal from the mobile phone speaker at connection 15 requires some attenuation. A reduction in input voltage of ⅔ results from the voltage divider. The input should be keep around 200 mV maximum. Requirements on current limiting and frequency response are not optimized here, but the system works fine. Variations to the circuit component parameters and the addition of components may improve the protection of components and the frequency response of the system the method of this invention remains unaffected.

The invention also allows the transfer of audio date between mobile phones and devices that record audio or play audio like tape players and digital music players to the phone extensions and peripherals on the network. The audio is transferred from the headphone signals into the Phone Extension Interface card in place of the mobile phone connection. Alternatively, the audio headphone jack may be plugged into the basestation side of the Phone Extension Interface card. Phone jack adaptors and converters may be required.

Depending upon the user's particular needs these accessories may accompany this invention. If a wired service provider is used with this system, such a button could also be triggered to effectively disconnect the service provider connection to the home or office. Such circuitry is not shown here but one skilled in art can activate a switch to do. The switch should reside close enough to the phone interface box to disconnect the desired portion of the home or office phone network from the wired telephone service provider. Such a switch can toggle the control of the home or office wiring between the wired telephone company and basestation. Upon activating the mobile phone through a means of controlling the mobile phone from an extension, the switch disconnects the wiring from being feed by the wired telephone service and brings up the phone basestation powered system. Using this switch also makes possible to receive calls from the outside when a wired service provider is still maintained. In this case, the switch detects the ring from outside wired line service. It then switches the control of the wiring from the basestation to the wired service provider. The switch isolates signals from the outside, and also provides a means of communicating with the basestation. Such means of communication may be a short ranged wireless signal with adequate coding, or a even a touch tone signal generator on the line.

In the LG4400 cell phone used here, the touch-tone audio signals are not decoded in the phones headphone jack. If this feature were designed into the phone with an alphabet assigned to the talk and send buttons, we would be able to directly dial the telephone from the touch-tone signals provided by our basestation and phone extension. Also, the ringer tone on the phone is not sent through the headphone audio either. If this were the case, our system could recognize ring tones directly through the signals from the mobile phones headset jack.

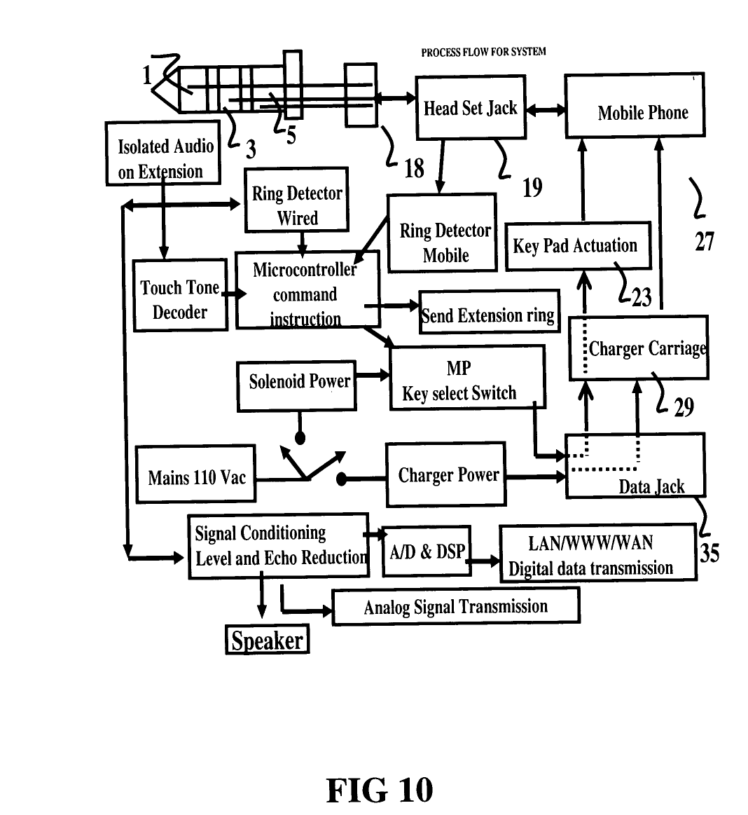

Nevertheless, we introduce this invention with the understanding that other ways to connect the data will continue to develop and be recognized by those in the art. Till then we disclose a way to make this invention without having to have significant software investment. FIG. 10 shows a flow chart indicating the control process flow of a full system. Thus we use the robotic finger dialer to dial. To perform the ring detection and to send a ring alert to the extensions, we use a microphone, not shown, near either the cable connecting the mobile to the basestation or in the holder unit depending upon the packaging. The tone is recorded by setting the phone to ring. Then a signal processing method for example cross correlation is used to recognize the signal. A threshold detector then triggers the circuit to ring the extensions on the phone lines.

Till all communication becomes completely performed on wireless devices, this invention offers a way for people to save money on their phone bills by having one type of phone service, namely a mobile wireless service. Also the users of this invention save money by not having to throw away their wired phone equipment as short-range digital wireless devices develop. The invention also provides convenient ways for users to keep their comfort zone with technology by allowing the use of their existing wired equipment. Users also still maintain the comfort of having a home phone number even though they have no home wired service. To those with disabilities such as hearing difficulties or arthritis this invention lets them have the freedom to control their mobile phone from their favorite wired-phone extension or peripheral device. The invention does also makes simple the connection of a mobile phone to the home or office wired network so the expanded feature of the mobile phone can be used.

Dialing Method:

A method is further described as a means of dialing the mobile phone from the phone extension. Those skilled in the art are able to implement the description in various hardware and software configurations. Nevertheless, such methods are still claimed as a means of dialing and answering the mobile phone for this extension.

The proprietary nature of cellular phones data port connections results in many configurations without standards. Thus to gain access to the port with new products usually requires marketing and business arrangements with various cellular phone manufactures and service providers. To work around, several means of controlling the mobile phone from with the Mobile Phone Extension are claimed. One already described is by using a finger-robot that provides mechanical actuation of the button on the mobile phone. Another method also previously described uses voice commands that are recognized by the Mobile Phone Extension, or by the mobile phone. Yet another method is the direct connection to the serial port, either RS-232 or USB of the phone.

Further details of a voice command system are now disclosed using a Bluetooth enabled mobile phone. Bluetooth is a communication protocol that compresses speech to result in less required bandwidth. Additionally, mobile phones equipped with this capability are also equipped with voice recognition and dial features. Such voice commands are accessed through a wireless Bluetooth headset. A DSP chip like a Texas Instrument TI320C may be used instead of or with a microcontroller to aid in the speech and tone recognition commands. The capability and complexity are dependent upon the marketing approach and product line level.

As more mobile phones come standard with Bluetooth, it is expected those users will invest in a Bluetooth wireless headset or earpiece. It is thus desirable to offer the Mobile Phone Extension as inexpensive as possible but allow for all of the features of a wireless headset through the wired phone resources of the home or offices. Since the wired home resources are not expected to go away and the many wired phones in use will remain so for some time. What we hope to provide for those users is a reduction in telephone cost by using those resources with their mobile phone through the Mobile Phone Extension.

The Mobile Phone Extension can contain its own Bluetooth transceiver or use the wireless earpiece or headsets. In this manner, the first marketing of the invention as a convenient adaptor with circuitry connecting the wired phone resources to the wireless headsets that talk with the mobile phone. This approach is unique for our market. First, this approach offers reduced product cost by excluding a Bluetooth Transceiver in the Phone Extension basestation. Secondly, it avoids the need for unraveling the proprietary connections to the mobile phone. These points yield a nice marketing position when introducing the Mobile Extension Products.

To use the wireless Bluetooth connection, the customer purchases a mobile phone and earpiece that are both Bluetooth enabled and support voice control. We use throughout the words earpiece, headset, and Bluetooth transceiver similarly. They perform the same functional, and all have a transceiver capable of sending duplex audio and have an analog-audio input and output function. These devices are connected the Mobile Phone Interface Card, and then turned on. Now instead of the Mobile Phone Interface Card having a direct connection to mobile phone audio jack, the connection is made to the earpiece. The equivalent connection is made either acoustically or electrically. Electrically, the connection is a similar scheme as that shown in FIG. 7, but the mobile phone is replaced by the transceiver. These earpiece and mobile phone are power by the appropriate charger signals. The chargers also maintain the battery levels in the phone and the headset as needed.

To understand the operation we describe some details of how the basic earpiece and voice command with a Bluetooth phone operates. The earpiece or headset has a button required pushing to activate the voice control of the mobile phone and to answer the phone. The user pushed the button and the phone is answered or the voice-command is spoken. The acoustic signal is received in the microphone in the earpiece. The phone sends audio prompts to earpiece and the user replies with spoken commands. The data is exchanged between the earpiece and the mobile phone via the Bluetooth RF between devices. When not using a wireless earpiece the voice commands are issued directly into the mobile phone handset.

A method is now described to make the wireless earpiece operate with the Phone Extension. In the presented method the mobile phone is controlled by the through the earpiece transceiver by the Mobile Phone Extension. There are two cases, to consider. One is where the earpiece requires the mechanical connection acoustic signals and mechanical switch activation. The other is where an electronic interface exists with the earpiece.

If the earpiece has only a button to activate voice command, then one means of controlling the earpiece is to use a robotic finger to press the button that activates the voice control feature. The analog acoustic signals to the microphone, and from the speaker are acoustically coupled in a chamber housing the earpiece. The chamber also includes a microphone and speaker that are electronically connected to the Mobile Phone Extension Interfaces. The earpiece or headset is placed into a holder containing a chamber to allow good acoustic transmission and reception between the microphone and speaker of the Phone Extension Interface and the speaker and microphone of the earpiece respectively. In this manner speech commands are sent from the extensions on the Mobile Phone Extension. To activate the button of the earpiece or headset, a touch-tone key is pressed on the phone extension. The touch-tone is decoded and recognized to activate the push button through the mechanical finger through a solenoid actuator. The audio is directly coupled through the air in the chamber. Care is required in designing the chamber with absorbing material and cross-talk decoupler is required to get the best audio quality.

A purely electronic connection is possible when the headset or earpiece is equipped with an analog audio input and output and control button access. This may also apply for a Bluetooth transceiver any RF transceiver capable of controlling the phone and exchanging real time audio. What is important is the transceiver has a jack to use with a wired headset, or contains connectivity options for an external microphone and speaker, and activation button. In that manner an off-the-shelf solution is available because the Phone Extension Interfaces phone jack will plug into the Bluetooth transceiver.

The operation is as follows. When the phone extension presses the talk-button to answers a mobile phone call a unique touch-tone signal is generated. The call then proceeds as usual until an end-button is pushed. When dialing is to begin, again the talk-button is pushed on the phone extension. Then the user is prompted for a voice command. Alternatively, a touch-tone sequence is entered to dial the call.

Analog touch-tones are not usually recognized when sent through the analog headset of the mobile phones. This is the case for the LG4400. Similarly digital wireless audio transmission usually use audio compression with coders and decoders called Codecs, like Bluetooth, and do not always pass touch-tones through the wireless connection. In this case, we send prerecorded voice commands to the headset or directly to the mobile phone when the touch-tone key is pushed. Thus we establish a translator of touch-tones to voice commands.

In cases when no electrical interface to the phone or earpiece is available, a mechanical finger actuator is used to push the button. It is activated when detection circuitry detects a special voice command or touch-tone code.

In the other case where the earpiece has an analog electrical interface, the Phone Extension Interface exchanges electrical signals instead of acoustic signals. Manufacturers may need to modify their earpiece to allow electrical connections to the microphone, speaker, and voice command activation switch. In this configuration, the Phone Extension Interface, can decode a special speech command or touch-tone code and activate the voice command by activating the electrical equivalent of the push-button switch.

In the case where activation is by electrically closing the switch a method of solution is as follows. The switch is a transistor or equivalent switch activated in the earpiece or phone from a DC signal generated by the touch-tone decoder upon recognizing a prescribed activation code. After activation the user of the Phone Extension hears and responds verbally or issues touch-tones to the audio promptings from the mobile phone. When touch-tones are issued and the particular mobile phone or earpiece does not have the ability to recognize touch-tones, corresponded prerecorded speech audio is played upon issuing the touch-tone commands.

An implementation of touch-tone decoding is by using the integrated circuit CM8870 from California Micro devices. The control logic is provided by a microcontroller like the PIC16F84. The recorded voice commands are done with a record and play chip available from Digikey as part number ISD2560P-ND. Other solutions exist, like using a DSP processor such as a PIC-DSP or similar with word and number synthesizer. A translation table of touch-tone key combinations is made to correspond to a voice command used by the phone. Each number and symbol corresponding to the touch-tone sequence has its spoken equivalent prerecorded on the ISD2560P chip. When keys on the Phone Extension keypad are pushed, the corresponding spoken equivalent is played through to the earpiece and sent to the mobile phone. The party on the phone extension can also hear the spoken commands when using touch-tone mode. A lookup table is used to know what spoken command is to be played for the touch-tone sequence. For multiple touch tone-key sequences a time delay threshold is set.

A touch tone control language is developed to correspond to the mobile phone voice command system prompt menu. Some of these may also accept touch-tone options. When multiple keys are pressed a time gate is used or a selected end character like * is used to terminate the sequence of keys. Another symbol like ** is used to restart the command, by issuing a command not recognized or to go back to the menu. Clearly the chosen symbol set must not conflict with common touch-tone telephony menus. Since phones have difference voice menu systems, the user of the Phone Extension Interfaces can have the option to record the commands. Optionally, the Mobile Phone Extensions with the translator may be sold with prerecorded commands made for each of the major mobile phone providers. Optionally, an LCD or equivalent display of the commands is also available on the Mobile Phone BaseStation or Mobile Phone Interface Cards.

This application discloses a method to make the Mobile Phone Extension with a wireless connection using a Bluetooth enabled phone and Bluetooth earpiece. What has been described is a low cost method to provide mobile phone control with minimal need to access the communication protocol between the Bluetooth transceiver and the mobile phone. With cooperation by mobile phone and accessory manufactures, access to the audio signals on the Bluetooth earpiece or transceivers may be made possible. The earpiece decodes the touch-tones and then sends the digital control commands via voice commands or to operate the mobile phone.

Whether using an earpiece or a stand alone transceiver a claim in this invention is the use of a convenient way for implementing control of a mobile phone from Mobile Phone Extension via a Bluetooth or equivalent audio wireless connection through an transceiver device such as an earpiece, headset, or standalone audio transceiver. This claim allows the Mobile Phone Extension to function effectively without using a Bluetooth enable computer or other Bluetooth telephone device system. The transceiver devices may be sold separately as add-on module to phones, wireless headsets, earpieces, or transceivers but contain option to connect to the Mobile Phone Extension.

If the audio communication wireless link has provision for decoding analog touch-tone signals in the transceiver, then the touch-tones are sent right into the analog input of the of the audio jack of the mobile phone or wireless transceiver. In the case of analog mobile phone connections or analog wireless RF links there is no problem doing so. It may not generally be the case for digital audio processing on mobile phones.

To make a straight forward touch-tone interface for a digital wireless audio connection what is needed is a DTMF touch-tone decoder in the Bluetooth transceiver at audio analog inputs. In this way the dialing and operational commands from extension keypads of the Mobile Phone Extension are directly translated to corresponding commands on the mobile phone. Thus we claim the use of a Bluetooth or RF transceiver module have a touch-tone decoder resulting in corresponding wireless messages that are exchanged between the mobile phone and resulting in the issuing of corresponding operational commands to touchtone inputs. Such an addition can be made into the earpiece, headset, or audio transceiver.

When the touch-tone decoder is not available in a Bluetooth transceiver as described another option exists to provide a standard interface. Bluetooth phone dialers software programs for PDA exist for example on the Palm devices with a Bluetooth connection. A more standard interface exists to these devices and a program is more easily written to receive input and send the dialing and operational commands. This approach works but requires much more hardware and software work to operate the Mobile Phone Extension.

Another approach to control the phone wirelessly might be to interface a Bluetooth phone like that from sold by Olympia out of the state of Oregon. It is not clear if the signals from the wired phone can be used to control the mobile phone.

To summarize the marketing approach, the first and less costly approach for wireless control of the mobile phone with the Mobile Phone Extension is to claim the use the voice command with a modified earpiece or transceiver allowing audio and control connections. The next logical progression is to claim a RF transceiver like said modified earpiece with touch-tone decoding in an earpiece or equivalent transmitter. This then allows for seamless use of touch-tone controls to operate the mobile phone from the Mobile Phone Extension. An alternative to the later is to use the Mobile Phone Extension with touch-tone key speech recognition coding. The full implementation is to use a Bluetooth transceiver integrated into the Mobile Phone Extension basestation.

To help disconnect from the at the control of the Mobile Phone Extension the wired phone service, a touch tone decoder is used to recognize a key code to turn off the outside wired connection. After this is acknowledged the power for the Mobile Phone Extension is activated. An audio tone or dial tone different from that of the wired phone company is also provided. The ringer as stated is triggered by a Bluetooth received single or by using the microphone to recognize the signal from the audio of the mobile phone.

Audio Speech Recognition Dialing and Control

The apparatus and methods describe above were demonstrated and proven possible using a LG6100 mobile phone purchased at BestBuy. The Phone Extension Interfaces was connected to the headset port of the phone. This phone does not have Bluetooth, but was popular. Today, LG has newer models that exhibit similar features. This phone has the desirable features that accommodate the Phone Extention Interface technology:
1) A single button on the right side of the phone will allow the for digit voice dial.
2) A switch in the headset that when a button on a special headset is pushed allows for answering, terminating, and toggling between calls.
   These two features of this phone allow the Phone extension to operate by

1) Answering, terminate and switch calls by electronically toggling the headset lines connecting to the phone. This feature is activated by recognizing touch-tone signal appearing on the wired line. The touch-tone decoding is done with the Mitel 8870 or equivalently obtained through DSP with other chips. The user of the phone extension hangs up a call by pressing a digit or sequence on the wired phone. The touch-tone decoding occurs in the phone extension interface, and then toggles or creates the necessary signal on the headset of the mobile jack. The result is the mobile phone call is answered, terminated or mode of operation or line switched.

The handset or headset of phone extension, either local basestation, wired extension, or cordless extension, or other wireless Bluetooth, or other RF extension, is put in extension mode by pressing a key on said phone extension. Touch tone decoding activates is used to:
1) Activate an electronic switch to toggle the LG6100 or equivalent mobile phone to answer, terminate, or switch call.
2) To dial the phone a key or button, or sequence is pressed on the phone extension, and that is touch tone decoded. Upon recognizing the correct dial button or code, the Phone extension interface sends signals to actuate an actuator to mechanically push the voice dial button.

Upon pushing the voice dial button, the LG6100 response with audio request for voice dial, digit-dial, voicemail, etc. The user of the phone extension then response verbally to the audio prompt from the cell phones as usual. The audio is exchanged between the phone extension and the mobile phone. The number is dialed by digit-dial commands spoken over the phone extension. Optionally, the user may key in numbers and they will be touchtone decoded. The decoded numbers can be stored in memory if desired, and queued to a audio play chip to produce the spoken numbers sequence over the audio connection between phone extension and the mobile phone as describe previously.

Additionally, upon receive of spoken digits, a speech recognition device can be used to recognize numbers and store them in memory. This feature is useful when receiving numbers from directory assistance. Instead of being directly connected to the call number, the number is recorded into a memory that can be saved or downloaded to the mobile phone. This claimed feature is workable in the phone extension basestation, or will stand-alone in mobile phones.

The result is a simple connection of the phone to the home and office phone wired resources. Other means of performing said connection are possible with prescribed mobile phones. OEM phone manufactures can customize their switching capability to enable a simple interface to the telephones through a phone extension interface as described.

The system described is convenient because it just plugs into a phone through the headset jack. Thus depending upon the manufacture of the wired phones, the appearance of a basestation and special unit is not necessary by incorporating a jack on the phone and using the Phone Extension interface as described. The mobile phone is placed inside a holster either standalone or within the base station.

It is also conceived that when a wired phone service is used, the power to power the lines would be supplied. When operating in mobile phone mode, the touch tone signals would be filter or switched from being transmitted on the wired phone service line outside the home or office. Thus only locally would the touch tone, or equivalent messages such as wireless, be sent between said phone extensions and the mobile phones.

Multiple mobile phones are also capable of being connected the phone extension. The phones will be selected by a discriminating touch one command, such as *1, *2, or *xxxx, *xxxx, etc. to have the phone extension connect to the mobile phones.

To those skilled in the art, other modifications, codes, and messaging schemes are recognizable, but nevertheless these are claimed as a means of connecting a mobile phone to the wired home and office system.

It is also claimed that the telephones both mobile and phone extension are able to be controlled by a motional command systems such as described by the authors other patent application. In the system a control surface, perhaps a finger, stylus, hand, or other gesture would send a command to the phone through the audio jack. The phone or pad is the sensing surfaces. Items are moved in the database, or active items displayed on the screen such as menus. This use of motional command systems, may comprise electrostatic or electromagnetic, or be comprised of video recognition, or comprised of infrared sensing.

Swirling the finger or stylus or control surface in a clockwise direction means advance forward.

Swirling the finger or stylus or control surfaces in a counter clockwise circle means rewind or backwards.

The following are commands are understood to be issued by any control surfaces:

A pulse forward toward the phone means play or go ahead.

A double pulse within a reasonable time window means stop.

A command with upward swipe means bring forward the last item.

A cmmand with an downward swipe means send back the last item.

A swipe to the right is used to invoke next one. When followed by hand pulses, the system moves to the next window underneath or layer in the menu.

A swipe to the left is used to invoke back one. When followed by hand pulses, the system moves to the previous window underneath or goes back one in the menu.

Such a communication command systems is claimed for electronics phones, PDA, and electronic audio and video, and computer devices.

It is to be recognized as part of this invention that performing a connection to the audio analog signals via circuits as described herein is equivalently done either through a jack plug connection or made internals to the electronic apparatus.

1. An apparatus for communicating through a mobile phone service from wired phone networks by connecting the mobile phone headset port through a phone extension interface system connected a phone to wired network as a basestation and further comprised of:
a. a mobile or cell phone having a self-contained wireless transceiver connected to a wireless large area network;
b. a self-contained wired phone network with a basestation phone and at least zero phone extensions or zero devices on the network;
c. a connection for the exchanging duplex audio data between the basestation and phone extensions on the network;
d. a control circuitry allowing the operation of the mobile phone from the phone extension through the said network;

2. An apparatus as in claim 1 comprising a local electronic communication link between transceivers associated with the mobile phone and a basestation;

3. A basestation as said in claim 2 that routes and connects calls from the mobile phone via the mobile phone transceiver to devices on the local network of the home, office, or place of business;

4. A communication link as in claim 2 that supports duplex data including digital and analog signals;

5. A communication link as in claim 2 including one or more of the following signal types; audio, video, or computer data send back and forth via standard local network protocol;

6. A basestation as in claim 3 supporting routing and connection to local building or intranet telephone wiring in either digital or analog phones wiring systems;

7. Said basestation in claim 3 that supports a connection to local CATS, Ethernet, Bluetooth or other computer type networks;

8. A basestation as in claim 3 comprised of one, more, or multiple microprocessors, digital memories, and communication interfaces for example, a voice recognition systems or touch tone decoder systems, that allows the user to setup control commands of household or local network devices;

9. A basestation as in claim 3 where the microprocessor interfaces to an external computer connected to the basestation via a network card using standard protocol;

10. A basestation as in claim 3 where the microprocessor is a personal computer;

11. A basestation as in claim 3 that consists of an apparatus for providing the mobile phone signal from an antenna placed outside of the home;

12. A basestation as in claim 3 capable of providing notification to devices on the network when they are being requested or accesses by the network such as a ringing the bells on the phone extension handsets, e-mail notification, or sounding an alert signal when a FAX comes in; or simply providing an audio or electronic response when poled by the control systems;

13. An apparatus as in claim 2 the transceiver communicates via a nonwireless connection to the basestation when the mobile phone is plugged into the basestation;

14. An apparatus as in claim 2 where the transceiver communicates via a nonwireless connection to the basestation when the mobile phone has a wireless headset or wireless audio transceiver that is connected to the phone extension interface resulting in the connection of a mobile phone audio and digital data to the wired phone extension.

15. The transceivers in claim 2 communicate in wireless mode using wireless low power short-range radio wave communication methods consistent with commercial communication techniques between wireless phone handsets, or wireless network connections;

16. The transceivers in claim 2 communicate in wireless mode via mobile phone connection to a mobile phone in the basestation.

17. A method where the transceiver in claim 2 uses a wireless communication link consists of transceivers using a low-noise low-interference modulation technique such as spread spectrum;

18. A switchless connection between speaker and microphone analog jack allowing duplex communication via standard analog or digital protocol.

19. A mobile phone transceiver as in claim 2 is switch able to the on position either by a switch on the phone transceiver or electronically from signals generated by control signal issued from the basestation.

20. A phone transceiver as in claim 2 that is in the form of an adapter that fits onto the mobile phone.

21. A basestation as in claim 1 containing a recharging and power unit for the mobile phone.

22. A basestation as in claim 1 having provision for addition of a local phone handset of either wireless, nonwired, or cordless type.

23. A basestation as in claim 1 having a provision of adding storage devices as DVD ROMs, DVDRWs, and stick type or memory cards.

24. A basestation as in claim 1 with USB type hub built in so other user devices are easily attached and addressed through the home network.

25. A basestation as in claim 1 that is connected to a computer with a user control interfaces program for select desired call routing patterns to specific resources.

26. A phone transceiver as in claim 2 connecting between the phone and the basestation analog outputs from the mobile phone by using a microphone and or video camera or by using circuitry to capture signals from the audio or video output jacks.

27. An apparatus that attaches to mobile phone connecting the audio and or the data output, or an equivalent circuit that gets the audio, of the mobile phone and makes a local RF link to a basestation that makes the connection of the call available to other phone extensions connected to the hardwired phone lines.

28. A basestation as in claim 1 that provides a transferred call via a local area wireless network to extensions hardwired to the phone lines of the home or office.

29. An apparatus as in claim 1 device/circuit embedded into mobile/cell phones that makes a two way local area network connection for voice and data available to phone extension on hardwired phone lines throughout the home or office.

30. An method of using speech recognition and speech synthesis and touch tone coding and decoding to communicate between phone extension and a basestation as in claim 1 over digital lines.

31. A method of using the method of claim 30 where the call is call of the mobile phone is controlled by sending audio and push button signals through the headset connection.

32. A method of 30 further controlling the phone by using mechanical actuation or contact switching such a magnetic to actuate the mobile phone via speech or touch tone commands on a phone extension.
